(19) United States
(12) Patent Application Publication
(10) Pub. No.: US 2010/0326171 A1
(43) Pub. Date: Dec. 30, 2010

(54) SMOKE GENERATION AND LEAK DETECTION SYSTEM

(76) Inventors: GENE STAUFFER, Moreno Valley, CA (US); Kenneth Pieroni, Yorba Linda, CA (US)

Correspondence Address: STETINA BRUNDA GARRED & BRUCKER, 75 ENTERPRISE, SUITE 250, ALISO VIEJO, CA, 92656, US

(21) Appl. No.: 12/492,410

(22) Filed: Jun. 26, 2009

(51) Int. Cl. G01M 3/04

(52) U.S. Cl. 73/40.7

(57) ABSTRACT

In accordance with the present invention, there is provided a leak detection device and method of using the same. The leak detection device of the present invention employs the use of phase change vapor generation to provide a visual leak indicator, and is adapted to quickly and accurately identify the location of leaks in many types of fluid systems. The leak detection device and related leak detection methodology of the present invention can be used to identify leaks in many large systems such as HVAC systems and ductwork, transportation containers, recreational vehicles, clean rooms, and any other large sealed system.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field of the Invention

The present invention relates generally to leak detection in fluid systems and, more particularly, to a leak detection device adapted to facilitate the filling of a fluid system with a visible vapor for purposes of inspecting the same and detecting leaks therein.

2. Description of the Related Art

Numerous currently known technologies include fluid systems which contain and/or operate using a fluid (e.g., a gas, liquid or combination of both). By way of example, automobiles include several systems which contain and rely upon the use of a fluid in their operation, including the fuel system, the exhaust system, the hydraulic power steering and brake systems, and the heating, cooling and ventilation (HVAC) system. In addition to automobiles, numerous industrial machines, household HVAC systems, and other devices employ the use of fluids during the operation thereof. Such fluids include, for example, gases such as air or an evaporated system liquid, fuel, hydraulic fluids, manufactured gases and liquids, as well as others.

In almost all circumstances, it is important, if not crucial, that the fluid system be properly sealed to prevent leakage of the system fluid therein. By way of example, in an automobile fuel system, the gas tank and gas lines must be thoroughly sealed to prevent gasoline fumes from escaping to the ambient environment as could otherwise create numerous hazards. In HVAC systems, it is important to seal the ducting which transports the conditioned air in order to maintain the efficiency of such system.

In many cases, leaks in fluid systems are very difficult to detect and/or locate since the leak is small and/or in a location which is not easily accessible. In the prior art, a variety of devices and corresponding methods have been devised to detect leaks in fluid systems. The most common leak detectors known in the prior art utilize a visual indicator to locate a leak so that the leak may be repaired. For example, in prior art liquid based fluid systems, liquid dyes are often used as visual indicators for detecting leaks in such systems. In this regard, the visual indicator (i.e., the liquid dye) is dispensed into the fluid system, with leaks being detected by locating places on the system where the liquid dye has escaped therefrom. In most instances, the liquid dye will leave a visually apparent dye trace at the leak site, the liquid dye itself also typically being visible at the leak site. However, as will be recognized, the use of a liquid dye as a visual indicator in a leak detection device is usually not useful for fluid systems wherein a gas rather than a liquid serves as the operative fluid, or in fluid systems which must seal vapors created by the system fluid.

For those fluid systems such as the aforementioned gas based systems and systems which have vapors, leak detection devices employing the use of vaporized dyes or smoke have also been developed in the prior art for detecting leaks in such systems. Indeed, finding leaks by filling a system with smoke or another type of visible vapor and inspecting for points of egress is a method that has been used in the leak detection field for many years. Some of the earliest known methods resorted to techniques such as placing a bucket of smoldering oily rags inside the system or enclosure to be inspected. The smoke would fill the system and exit through any openings. While effective in systems of sufficient size to accommodate a container with a fire, this primitive smoke production system presented obvious problems with contamination and the hazards of burning materials. Such technique could also not be applied to smaller systems or systems with complex structures such as hoses, channels and ducting.

In about the mid-1990's, smoke generating leak detection devices were developed for the automotive industry. These leak detection devices typically employed the use of an electrical resistance heater and oil to produce the smoke or vapor. More particularly, these particular leak detection devices (which are still in widespread use today) include a heating element which contacts a smoke producing fluid to facilitate the production of smoke by one of two methods. In a first method, the heating element is located within a reservoir of the smoke producing fluid. In the second method, the smoke producing fluid is delivered to the heating element by blowing or spraying the fluid onto the heating element. More particularly, the smoke producing fluid is blown, sprayed or atomized through a nozzle onto the heating element which is located above the fluid reservoir. Pressurized air is used to flow, spray or atomize the smoke producing fluid through the nozzle. The heating element is purposely disposed above the fluid reservoir so that the blown, sprayed or atomized fluid which is not converted into smoke will return to the reservoir. The produced smoke or vapor is thereafter mixed with a gaseous fluid and propelled into the fluid system to be inspected under low pressure. As the fluid system being inspected is filled with the smoke or vapor, such smoke or vapor exit leaks in the system under the applied pressure.

The above-described leak detection devices have proven to be effective in small fluid systems since the source of the smoke or vapor is located outside of the system. Additionally, since the smoke or vapor is injected into the fluid system being tested, these leak detection devices have also proven to be effective in complex fluid systems since the propellant serves to move the smoke or vapor through small recesses and long lengths of tubing. These types of leak detection devices have further been refined over recent years to include precise temperature control of the heater, the use of medicinal mineral oil, and improved pressure regulation at very low pressures. One exemplary leak detection device of this variety is described in Applicant's U.S. Pat. No. 7,305,176 entitled Method and Device for Detecting Leaks Using Smoke, issued Dec. 4, 2007, the disclosure of which is incorporated herein by reference.

In other prior art leak detection devices of similar functionality to those described above, a vaporized dye is added to the smoke such that a trace of dye is left at the leak as smoke flows or billows through the leak. As previously explained, in general, currently known leak detection devices for producing smoke for leak detection comprise a sealed chamber in which smoke is generated by vaporizing a smoke-producing fluid using a heating element. The smoke within the sealed chamber is forced out of the chamber through an outlet port by air pressure from a source of compressed air pumped into the sealed chamber.

Though the above-described leak detection devices are well suited for use in numerous applications, such as in the automotive service industry as indicated above, there exists a need to employ smoke or vapor based leak detection technology in large systems that may be sensitive to the by-products of oil vapor. In this regard, existing automotive equipment leak detection devices are limited to producing relatively small volumes of smoke or vapor. When scaled up to produce higher volumes of vapor, large amounts of oil are also injected into the fluid system causing contamination that is difficult to remove. Additionally, the vapor from oil has a pungent and malodorous aroma. Low volume vapor production, contamination, oil residue and the bad odor of the vapor have limited the application of this technology to primarily internal combustion engine maintenance, which happens to be well suited to this application since the negative aspects of the vapor are fully compatible with the fluid systems being inspected.

An alternative method of producing visible vapor is to “boil” a liquid and collect the vapor produced from the phase change from a liquid to a gas. When this phase change occurs in a confined space at controlled temperatures, large amounts of concentrated vapor can be produced. This is the method employed in some theatrical “fog” machines. The most common liquids used are mixtures of water with various combinations of glycerin and/or glycols. However, this method of producing visible vapor cannot be directly employed for leak detection for several reasons. Firstly, although large amounts of vapor are produced, the vapor will only travel to the extent caused by the expansion during the phase change. This limits the size and complexity of the fluid system which may be tested. Secondly, connection of the vapor generator to a fluid system to be tested is difficult because of the very high temperatures required to produce large volumes of vapor. In this regard, making a sealed connection to the fluid system will transfer large amounts of heat into the fluid system, thus creating a high probability of damage thereto. Lastly, the use of nozzles or other typical connection means that isolate the vapor generator's heat from the fluid system being tested could cause significant cooling of the vapor and therefore considerable amounts of condensation at the point of entry and within the fluid system.

Despite the shortcomings set forth above, the potential use of the phase change method for producing vapor to be used in leak detection is still highly desirable for several reasons. In this regard, high volumes of vapor can be produced quickly. Additionally, the chemistry of the vapor producing liquid can be easily selected to vary and achieve desirable characteristics of the vapor. These characteristics include, but are not limited to, non-toxicity, low odor, low residue, the potential addition of desirable fragrances, the potential addition of cleaning or sanitizing agents, potential variations in the density of the vapor, and potential variable persistence of the vapor (i.e., the length of time for dissipation). The present invention, as will be described in more detail below, effectively overcomes the drawbacks associated with phase change vapor generation discussed above, and provides a leak detection device which makes use of the desirable characteristics or attributes of phase change vapor generation, allowing the same to quickly and accurately identify the location of leaks in many types of fluid systems.

### SUMMARY OF THE INVENTION

In accordance with the present invention, there is provided a leak detection device and method of using the same. The leak detection device of the present invention employs the use of phase change vapor generation to provide a visual leak indicator, and is adapted to quickly and accurately identify the location of leaks in many types of fluid systems. The leak detection device and related leak detection methodology of the present invention can be used to identify leaks in many large systems such as HVAC systems and duct work, transportation containers, recreational vehicles, clean rooms, and any other large sealed system.

The leak detection device constructed in accordance with the present invention comprises a boiler, an injection pump, a vapor producing liquid storage reservoir, and a blower. The injection pump is operative to facilitate the selective infusion of vapor producing liquid or solution from within the storage reservoir into the boiler. The boiler itself includes a heating element which, when energized, is operative to convert the vapor producing liquid infused into the boiler by the injection pump from a liquid phase into a gas or vapor phase. The produced vapor is communicated from within the boiler to a suitable air conduit fluidly connected to the blower.

In the current embodiment of the leak detection device of the present invention, the fluid communication between the boiler and the air conduit is facilitated through the use of a metal vapor discharge nozzle included on the boiler. The vapor discharge nozzle is provided in a shortest practical length, with the same being advanced into the interior of the air conduit via an opening therein which is enlarged to a point wherein metal-to-metal contact between the discharge nozzle and the air conduit is completely eliminated, i.e., the diameter of the opening in the air conduit exceeds the maximum outer diameter of the discharge nozzle. The absence of metal-to-metal contact between the air conduit and the discharge nozzle prevents excessive heat transfer between the discharge nozzle and the air conduit. Since the temperature of the discharge nozzle can reach and exceed 600° F., direct heat transfer between the discharge nozzle and the air conduit could quickly damage any heat sensitive components within the junction. Additionally, any direct connection between the discharge nozzle and the air conduit could transfer sufficient heat to damage heat sensitive components connected to the air conduit, and could further reduce the performance of the boiler due to the additional thermal load. The expansion resulting from the phase change of the vapor producing liquid from a liquid to a gas facilitates the flow of the vapor from within the interior of the boiler, through the discharge nozzle, and into the interior of the air conduit fluidly coupled to the blower. Once the vapor flows into the air conduit and the blower is activated, the vapor is delivered through the conduit or a hose coupled thereto to the fluid system to be inspected. The minimal length of the discharge nozzle, and in particular that portion thereof advanced into the air stream flowing through the air conduit upon the activation of the blower, prevents excessive vapor condensation within the air conduit which could otherwise occur as a result of the cooling effect that would be facilitated by the use of a longer discharge nozzle. Additionally, the introduction of the vapor into the air conduit attached to the blower, rather than directly injecting the vapor into the suction port of the blower, prevents significant amounts of vapor condensation in the blower which could otherwise give rise to potential contamination and erosion problems in relation thereto.

In the leak detection device of the present invention, a washer preferably fabricated from fluorosilicone is placed around the discharge nozzle and effectively captured between the boiler and the air conduit. In this regard, the boiler and air conduit are mounted within a housing of the leak detection device in such a way that a slight spring force exists to press the boiler against the air conduit, the fluorosilicone washer thereby being compressed by this force and effectively sealing the boiler/discharge nozzle to the air conduit in a manner preventing the undesirable escape of vapor from the leak detection device. In this regard, the use of the washer between the boiler and the air conduit and the seal created thereby eliminates gaps or openings between the discharge nozzle and the air conduit which, though otherwise effecting thermally decoupling, would allow vapor to escape the leak detection device as the pressure in the fluid system being tested increases.

The leak detection device of the present invention further comprises a controller which is operative to allow the boiler and the injection pump to operate independently, and thus provide continuous and uninterrupted operation of the leak detection device. The controller also allows for selective variations in the amount of the vapor producing liquid or solution delivered to the boiler by the injection pump, and thus the amount of vapor generated by the leak detection device. The operational protocol of the controller avoids interruptions to vapor production by not allowing the operation of the injection pump to be inhibited while power is applied to the boiler. The controller, as well as the heating element of the boiler, is electrically connected to a power supply of the leak detection device.

In the leak detection device of the present invention, the smoke/vapor producing liquid or solution is preferably a mixture of water and glycerin. This mixture is used because it is commonly and reliably used in commercially available vapor generators, produces low odor, is non-toxic, and is inexpensive. However, the water/glycerin mix ratio and the amount of solution vaporized can produce significant changes in the effectiveness of the leak detection device in identifying fluid system leaks. As the amount of glycerin in the solution is increased, the density and persistence of the vapor also increases. By way of example and not by way of limitation, a preferred ratio of 80% water to 20% glycerin by weight is used when the leak detection device is to be primarily used in conjunction with HVAC leak detection. Other ratios may be better suited to other applications. Additionally, the optimum amount of vapor producing solution injected into the boiler by the injection pump is dependent upon the power applied to the boiler and the volume of air flow in the air conduit as created by the blower. In the exemplary use of the leak detection device of the present invention for HVAC leak detection, a 1,000 W boiler and a 105 CFM blower may be used with solution injection flows of about 3 mL/M to about 10 mL/M. Lower concentrations and flows may be unacceptably slow or inefficient in locating leaks. Additionally, higher concentrations and flows can overwhelm a user since, if a large leak exists, the work area will quickly become filled with vapor and the point of egress can no longer be identified. In this situation, if the persistence (i.e., the amount of time before the vapor dissipates) is too long, the work area becomes filled with vapor and work will be delayed until the area is cleared. Again, other boiler, air flow and solution mixtures may be better suited to other applications.

In using the leak detection device constructed in accordance with the present invention, vapor can be delivered to the fluid system under test in a controlled manner and through various size conduits. Indeed, if the vapor supply conduit is inserted into an HVAC duct approximately five to ten times the diameter of the conduit, the jet of vapor from the leak detection device will induce a draft at the open end of the duct where the conduit is inserted. This eliminates the need to seal the entry point of the fluid system being inspected. If the remainder of the fluid system is also unsealed, the vapor will travel quickly through the fluid system being inspected and reveal the locations of all leaks in the system. This significantly reduces the time to prepare for an inspection as well as the time to conduct the inspection. Thus, the leak detection device of the present invention allows a service or repair technician to quickly and accurately diagnose and locate leaks in many different fluid systems.

The present invention is best understood by reference to the following detailed description when read in conjunction with the accompanying drawings.

### BRIEF DESCRIPTION OF THE DRAWINGS

These, as well as other features of the present invention, will become more apparent upon reference to the drawings wherein:

FIG. 1 is a front view of a leak detection device constructed in accordance with the present invention as shown emitting vapor within a confined area for purposes of locating a leak.

FIG. 2 is a front view of a leak detection device constructed in accordance with the present invention, with a portion of the exterior housing being removed for purposes of revealing certain inner structural features thereof.

FIG. 3 is a left side view of the leak detection device depicted in FIGS. 1 and 2.

FIG. 4 is a top view of the leak detection device depicted in FIGS. 1-3.

Common reference numerals are used throughout the drawings and detailed description to indicate like elements.

### DETAILED DESCRIPTION OF THE INVENTION

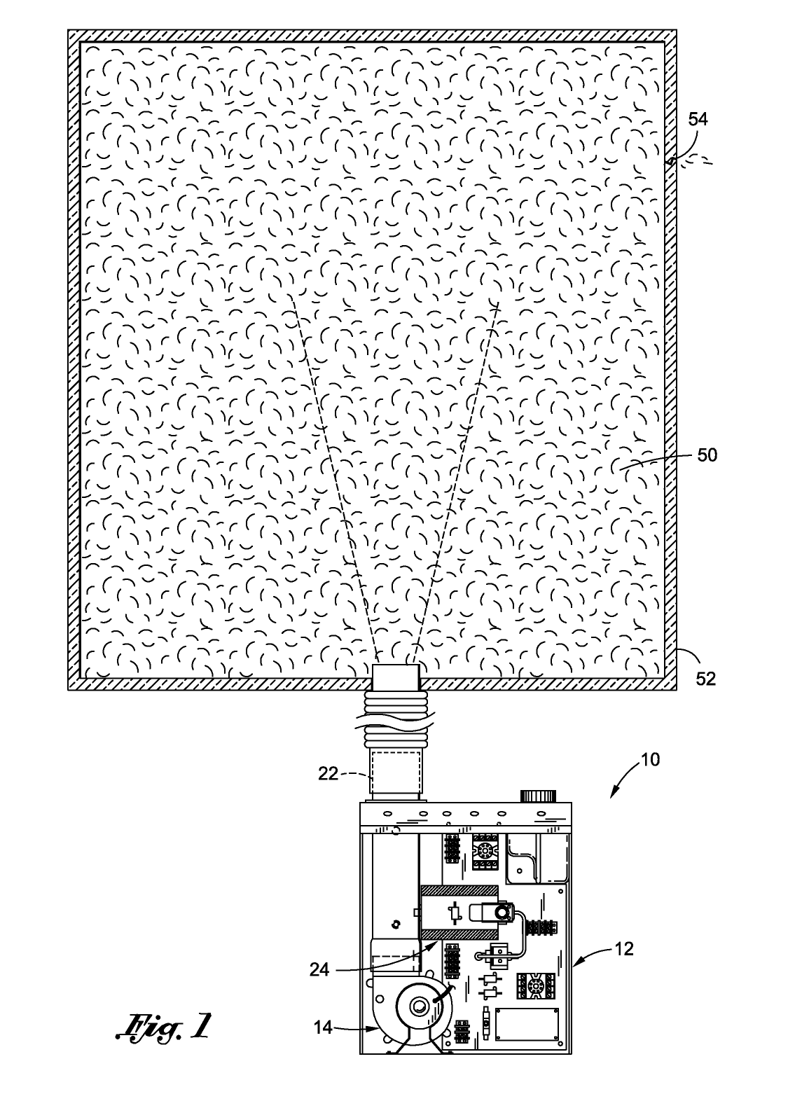

Referring now to the drawing wherein the showing is for purposes of illustrating a preferred embodiment of the present invention only, and not for purposes of limiting the same, FIG. 1 depicts a leak detection device 10 constructed in accordance with the present invention. The leak detection device 10 is specifically designed and configured to rapidly generate large volumes of smoke or vapor 50 within a room or confined area 52, in order to detect the presence of one or more leaks, such as 54. In this regard, the leak detection device of the present invention 10 is operative to generate phase change vapor to provide a visual leak indicator and is further adapted to quickly and accurately identify the location of leaks in many types of fluid systems, and in particular large systems such as HVAC systems and duct work, transportation containers, recreational vehicles, clean rooms, and any other large sealed systems.

As shown more clearly in FIG. 2, the leak detection device 10 comprises an exterior housing 12 which has a generally quadrangular configuration. In FIGS. 1-2, a portion of the housing 12 is removed for purposes of providing a clear visual depiction of the major structural elements of the leak detection device 10, such structural elements being described with particularity below.

In addition to the housing 12, the leak detection device 10 comprises a blower 14 which is mounted within the interior of the housing 12. The blower 14 defines an inlet port 16 and an exhaust port 18. The inlet port 16 is placed into fluid communication with ambient air outside of the housing 12 via an inlet opening which is disposed within the housing 12, such inlet opening preferably being covered by a mesh or screen like cover 20 which assists in preventing large particulates or debris from being drawn into the inlet port 16 of the blower 14 upon the activation thereof. As will be recognized by those of ordinary skill in the art, when activated, the blower 14 is operative to draw air from the ambient environment into the inlet port 16 via the cover 20, and exhaust such air from the exhaust port 18 in the form of a high velocity air stream. As will be discussed in more detail below, in an exemplary embodiment of the leak detection device 10, the capacity of the blower 14 is about 105 CFM.

In the leak detection device 10, fluidly coupled to the exhaust port 18 of the blower 14 is an elongate, tubular air conduit 22. As seen in FIGS. 2-4, the air conduit 22 has a generally circular cross-sectional configuration. Additionally, the air conduit 22 is preferably fabricated from a metal material. The air conduit 22 is preferably formed to be of a length such that the end portion thereof opposite that attached to the blower 14 shown in FIG. 2 protrudes from a prescribed side surface or side wall of the housing 12. More particularly, in the leak detection device 10 shown the air conduit 22 protrudes from that side wall of the housing 12 which is disposed in opposed relation to that side wall of the housing 12 disposed proximate the inlet port 16 of the blower 14 and having the cover 20 disposed therein. As will be recognized by those of ordinary skill in the art, the high velocity air stream exhausted from the exhaust port 18 of the blower 14 travels axially through the length of the air conduit 22 when the blower 14 is activated.

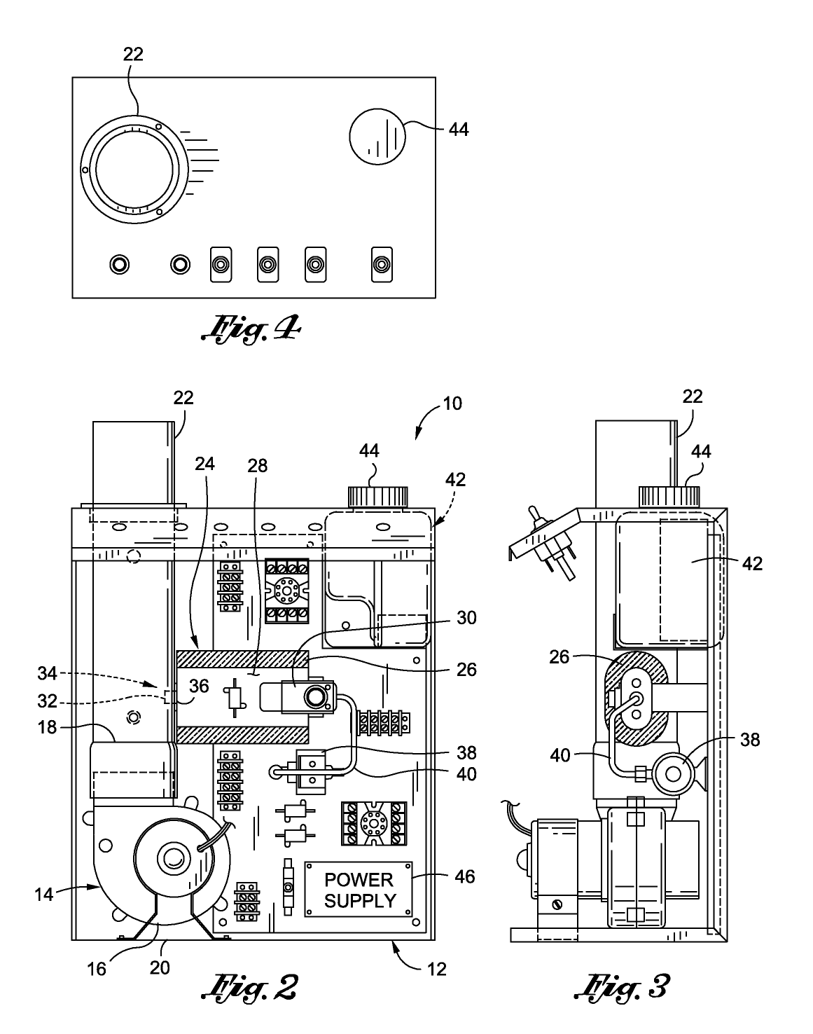

The leak detection device 10 of the present invention further comprises a boiler assembly 24 which, like the blower 14 and majority of the air conduit 22, is mounted within the interior of the housing 12. The boiler assembly 24 comprises a boiler vessel 26, as shown in FIG. 3. The boiler vessel itself defines an interior chamber 28 which has a generally circular cross-sectional configuration, and is of a prescribed internal volume. In addition to the boiler vessel 26, the boiler assembly 24 includes a heating element 30 which is attached to one end of the boiler vessel 26, and partially resides within the interior chamber 28. The use of the heating element 30 will be discussed in more detail below.

In addition to the boiler vessel 26 and heating element 30, the boiler assembly 24 includes a vapor discharge nozzle 32 which is adapted to place the interior chamber 28 of the boiler vessel 26 into fluid communication with the interior of the air conduit 22. The discharge nozzle 32 has a generally cylindrical, tubular configuration, and is attached to that end of the boiler vessel 26 opposite the end having the heating element 30 coupled thereto. One end of the tubular discharge nozzle 32 fluidly communicates with the interior chamber 20, with the opposite end of the discharge nozzle 32 fluidly communicating with the interior of the air conduit 22. Thus, as will be recognized, the vapor discharge nozzle 32 defines a continuous, uninterrupted fluid flow path between the interior chamber 28 of the boiler vessel 26 and the interior of the air conduit 22. Like the air conduit 22, the discharge nozzle 32 is preferably fabricated from a heat resistant material.

In the leak detection device 10, the discharge nozzle 32 is advanced into the interior of the air conduit 22 via a circularly configured opening 34 disposed within the air conduit 22. The opening 34 is preferably formed to be of a diameter which is enlarged to exceed the maximum outer diameter of the discharge nozzle 32 advanced therethrough. As a result, direct metal-to-metal contact between the discharge nozzle 32 and the air conduit 22 is eliminated, which provides certain advantages and efficiencies in the operation of the leak detection device 10 as will be discussed in more detail below. In an exemplary embodiment of the present invention, it is contemplated the diameter of the opening 34 will be approximately one half inch, with a maximum outer diameter of the discharge nozzle 32 being approximately three eights inch, thus resulting in a continuous annular gap of approximately one sixteenth inch in width being defined therebetween. In addition, the length or distance at which the discharge nozzle 32 protrudes into the interior of the air conduit 22 is preferably in the range of from about one quarter inch to about one half inch. Further, the orientation of the discharge nozzle relative to the air conduit is preferably such that a vapor flow axis defined by the fluid flow path of the discharge nozzle 32 extends generally perpendicularly relative to an air stream axis defined by the air conduit 22. but may be oriented at any angle from perpendicular to parallel.

In the leak detection device 10 of the present invention, a washer 36 shown in FIG. 2 is placed around (i.e., circumvents) the discharge nozzle 32 and effectively captured between the boiler vessel 26 and the outer surface of the air conduit 22. The washer 36 is preferably fabricated from fluororosilicone, though the present invention is not intended to be limited to any specific material for use in relation to the washer 36. In the leak detection device 10, the boiler assembly 24 and the air conduit 22 are mounted within the housing 12 in such a way that a slight spring force exists to press the boiler vessel 26 against the air conduit 22, the washer 36 thereby being compressed by this force and effectively creating a seal between the boiler vessel 26 and the air conduit 22. As will be described in more detail below, the seal created by the washer 36 prevents the undesirable escape of vapor from the leak detection device 10.

The leak detection device 10 further comprises an infusion or injection pump 38 which is also mounted in a prescribed location within the interior of the housing 12. The injection pump 38 is fluidly connected to the interior chamber 28 of the boiler vessel 26 by a tubular fluid flow line 40. In addition to putting the injection pump 38 into fluid communication with the interior chamber 28 of the boiler vessel 26, the flow line 40 also places the injection pump 38 into fluid communication with the hollow interior of a storage reservoir 42 of the leak detection device 10. As seen in FIG. 2, the storage reservoir 42 has the general shape and configuration of a bottle, and includes an externally threaded neck portion of reduced diameter having a closure cap 44 threadably engaged thereto. As further seen in FIG. 2, the neck portion of the storage reservoir 42 protrudes from that side wall of the housing 12 also having a portion of the air conduit 22 protruding therefrom. Such protrusion of the neck portion of the storage reservoir 42 from the housing 12 allows for the easy access to and selective detachment of the cap 44 from the neck portion of the storage reservoir 42, as is needed to periodically fill and re-fill the same with a smoke or vapor producing liquid. A preferred formulation for the smoke or vapor producing liquid preferably filled into the storage reservoir 42 will be described in more detail below.

As previously explained, the flow line 40 effectively places the injection pump 38 into fluid communication with both the interior chamber 28 of the boiler vessel 26 and the vapor producing liquid stored within the storage reservoir 42. In this regard, in the leak detection device 10, the injection pump 38, when activated, is operative to draw vapor producing liquid from within the storage reservoir 42, and to infuse the same into the interior chamber 28 of the boiler vessel 26. As will also be discussed in more detail below, it is contemplated that during operation of the leak detection device 10, the operation of the injection pump 38 will be controlled or regulated in a manner maintaining a prescribed level or volume of the vapor producing liquid within the interior chamber 28 of the boiler vessel 26.

In the operation of the leak detection device 10, once the interior chamber 28 of the boiler vessel 26 is at least partially filled with vapor producing liquid as a result of the activation of the injection pump 38, the further activation of the heating element 30 facilitates a conversion of the vapor producing liquid from a liquid phase into a gas or vapor phase. The produced vapor is fluidly communicated from within the boiler vessel 26 of the boiler assembly 24 into the air conduit 22 by the vapor discharge nozzle 32. In this regard, the expansion resulting from the phase change of the vapor producing liquid from a liquid to a gas facilitates the flow of the vapor from within the interior chamber 28 of the boiler vessel 26 and into the interior of the air conduit 22 via the discharge nozzle 32. Once the vapor flows into the air conduit 22 and the blower 14 is activated, the vapor is delivered through the air conduit 22, and any hose coupled thereto, to the fluid system to be inspected through the use of the leak detection device 10.

As indicated above, the discharge nozzle 32 is provided in the shortest practical length, with the same being advanced into the interior of the air conduit 22 via the opening 34 therein. Since the opening 34 is enlarged to eliminate direct contact between the discharge nozzle 32 and the air conduit 22, the absence of such direct contact prevents excessive heat transfer between the discharge nozzle 32 and the air conduit 22. Since the temperature of the discharge nozzle 32 can reach and exceed 600° F. during the conversion of the vapor producing liquid from the liquid phase to the gas phase, direct heat transfer between the discharge nozzle 32 and the air conduit 22 could quickly damage any heat sensitive components within the junction. Additionally, any direct connection between the discharge nozzle 32 and the air conduit 22 could transfer sufficient heat to damage heat sensitive or plastic components of the leak detection device 22 connected to the air conduit 22, and could further reduce the performance of the boiler assembly 24 due to the additional thermal load. Further, despite the high temperature reached by the discharge nozzle 32, the minimal length of the discharge nozzle 32, and in particular that portion thereof advanced into the air stream flowing through the air conduit 22 upon the activation of the blower 14, prevents excessive vapor condensation within the air conduit 22 which could otherwise occur as a result of the cooling effect that would be facilitated by the use of a longer discharge nozzle 32, i.e., the cooling effect of the air stream traveling over that portion of the discharge nozzle 32 which protrudes into the interior of the air conduit 22. Additionally, the introduction of the vapor into the air conduit 22 attached to the blower 14, rather than directly injecting the vapor into the inlet port 16 of the blower 14, prevents significant amounts of vapor condensation in the blower 14 which could otherwise give rise to potential contamination and erosion problems in relation thereto.

As also previously explained, the washer 36 is effectively captured and compressed between the boiler vessel 26 of the boiler assembly 24, and the outer surface of the air conduit 22, thereby creating a seal therebetween. In this regard, the seal created by the washer 36 effectively prevents the escape of vapor from between the boiler assembly 24 and the air conduit 22, despite the above-described annular gap being defined between the discharge nozzle 32 and the air conduit 22 as a result of the diameter of the opening 34 exceeding the maximum outer diameter of the discharge nozzle 32 as needed to thermally decouple the discharge nozzle 32 from the air conduit 22. As will be recognized, without the seal created by the washer 36, the vapor would be free to escape from between the boiler assembly 24 and the air conduit 22.

In the leak detection device 10, the smoke or vapor producing liquid or solution stored within the storage reservoir 42 is preferably a mixture of water and glycerin. As previously explained, this mixture is preferred since it is commonly and reliably used in commercially available vapor generators, produces low odor, is non-toxic, and is inexpensive. It is contemplated that the water/glycerin mix ratio and the amount of solution vaporized can produce significant changes in the effectiveness of the leak detection device 10 in identifying fluid system leaks. In this regard, as the amount of glycerin in the solution is increased, the density and persistence of the vapor also increases. By way of example and not by way of limitation, a preferred ratio of 80% water to 20% glycerin by weight is used when the leak detection device 10 is to be primarily used in conjunction with HVAC leak detection. Those of ordinary skill in the art will recognize that other ratios may be better suited to other applications. Additionally, the optimum amount of vapor producing solution injected into the interior chamber 28 of the boiler vessel 26 by the injection pump 38 is dependent upon the power applied to the heating element 30 of the boiler assembly 24 and the volume of air flow in the air conduit 22 created by the blower 14. In the exemplary use of the leak detection device 10 for HVAC leak detection, a 1000 W boiler assembly 24 and the aforementioned exemplary 105 CFM blower 14 may be used with solution injection flows of about 3 mL/M to about 10 mL/M. As also previously explained, lower concentrations and flows may be unacceptably slow or inefficient in locating leaks. Additionally, higher concentrations and flows can overwhelm a user since, if a large leak exists, the work area will quickly become filled with vapor and the point of egress of the vapor from the fluid system being tested can no longer be identified. In this situation, if the persistence of the vapor is too long, the work area will become filled with vapor and work will be delayed until the area is cleared.

In the leak detection device 10, the blower 14, the heating element 30 of the boiler assembly 24, and the injection pump 38 are each electrically connected to a power supply 46 which is mounted within the interior of the housing 12. The blower 14, injection pump 38, and heating element 30 of the boiler assembly 24 are also electrically connected to a controller. Importantly, the controller is operative to allow the boiler assembly 24 (and in particular the heating element 30 thereof and the injection pump 38 to operate independently, and thus provide continuous and uninterrupted operation of the leak detection device 10. The controller also allows for selective variations in the amount of the vapor producing liquid or solution delivered to the interior chamber 28 of the boiler vessel 26 by the injection pump 38, and thus the amount of vapor generated by the leak detection device 10. The operational protocol of the controller avoids interruptions to vapor production by not allowing the operation of the injection pump 38 to be inhibited while power is applied to the heating element 30 of the boiler assembly 24. The controller is also preferably connected to the power supply 46, which itself receives power from a suitable external source such as a conventional wall outlet.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A leak detection device, comprising:
a housing;
a blower disposed within the housing;
an air conduit fluidly connected to the blower and at least partially disposed within the housing; and
a boiler assembly disposed within the housing and operative to convert a vapor producing liquid infused therein from a liquid to a vapor, the boiler assembly including a vapor discharge nozzle which facilitates the fluid coupling thereof to the air conduit.

2. The leak detection device of claim 1 wherein:
the air conduit includes an opening disposed therein;
the discharge nozzle is advanced through the opening so as to partially reside within the air conduit; and
the opening and the discharge nozzle are sized relative to each other such that a gap is defined between the discharge nozzle and the air conduit, the gap being of a prescribed size as is operative to thermally decouple the discharge nozzle and the air conduit from each other.

3. The leak detection device of claim 2 wherein:
the opening has a generally circular configuration and is of a diameter of about one half inch;
the discharge nozzle has a generally cylindrical configuration and is of a maximum outer diameter of about three eights inch; and
the discharge nozzle extends axially through the opening such that a gap having a width in the range of from about one sixteenth inch to about one eighth inch is defined between the discharge nozzle and the air conduit.

4. The leak detection device of claim 3 wherein:
the air conduit defines an air stream axis;
the discharge nozzle defines a vapor flow axis; and
the discharge nozzle is oriented relative to the air conduit such that the vapor flow axis extends generally perpendicular to parallel relative to the air stream axis, and the discharge nozzle protrudes into the air conduit to a maximum depth in a range of from about one quarter inch to about one half inch.

5. The leak detection device of claim 2 further comprising an annular washer which circumvents the discharge nozzle and is compressed between the boiler assembly and the air conduit, the washer being sized and configured to create a seal between the discharge nozzle and the air conduit as prevents the escape of any vapor from therebetween as a result of the gap defined between the discharge nozzle and the air conduit.

6. The leak detection device of claim 5 wherein the washer is fabricated from a fluorosilicone material.

7. The leak detection device of claim 1 wherein the boiler assembly comprises:
a boiler vessel defining an interior chamber for accommodating a prescribed volume of the vapor producing liquid; and
a heating element operatively coupled to the boiler vessel and partially residing within the interior chamber thereof;
the heating element, when activated, being operative to facilitate the conversion of any vapor producing liquid within the interior chamber from a liquid to a vapor.

8. The leak detection device of claim 7 further comprising:
a storage reservoir for storing a prescribed volume of the vapor producing liquid;
a fluid flow line fluidly connecting the storage reservoir to the interior chamber of the boiler vessel; and
an injection pump which is integrated into the fluid flow line and, when activated, operative to pump the vapor producing liquid from the storage reservoir to the interior chamber of the boiler vessel.

9. The leak detection device of claim 8 wherein the heating element of the boiler assembly and the injection pump are each electrically connected to a controller of the leak detection device which is operative to facilitate the independent control and operation of the heating element and the injection pump.

10. The leak detection device of claim 9 wherein the controller, the heating element of the boiler assembly, the injection pump and the blower are each electrically connected to a power supply of the leak detection device which is disposed within the housing thereof.

11. The leak detection device of claim 1 wherein the boiler assembly is at least partially filled with a vapor producing liquid comprising approximately 80% by weight water and approximately 20% by weight glycerin.

12. A leak detection device, comprising:
a blower;
an air conduit fluidly connected to the blower and including an opening disposed therein; and
a boiler assembly operative to convert a vapor producing liquid infused therein from a liquid to a vapor, the boiler assembly including a vapor discharge nozzle which facilitates the fluid coupling thereof to the air conduit, the discharge nozzle being advanced through the opening so as to partially reside within the air conduit;
the opening and the discharge nozzle being sized relative to each other such that the discharge nozzle is thermally decoupled from the air conduit.

13. The leak detection device of claim 12 wherein:
the opening has a generally circular configuration and is of a diameter of about one half inch;
the discharge nozzle has a generally cylindrical configuration and is of a maximum outer diameter of about three eighths inch; and
the discharge nozzle extends axially through the opening such that an annular gap having a width in the range of from about one sixteenth inch to about one eighth inch is defined between the discharge nozzle and the air conduit.

14. The leak detection device of claim 13 wherein:
the air conduit defines an air stream axis;
the discharge nozzle defines a vapor flow axis; and
the discharge nozzle is oriented relative to the air conduit such that the vapor flow axis extends generally perpendicularly relative to the air stream axis, and the discharge nozzle protrudes into the air conduit to a maximum depth in a range of from about one quarter inch to about one half inch.

15. The leak detection device of claim 13 further comprising an annular washer which circumvents the discharge nozzle and is compressed between the boiler assembly and the air conduit, the washer being sized and configured to create a seal between the discharge nozzle and the air conduit as prevents the escape of any vapor from therebetween as a result of the gap defined between the discharge nozzle and the air conduit.

16. The leak detection device of claim 12 wherein the boiler assembly comprises:
a boiler vessel defining an interior chamber for accommodating a prescribed volume of the vapor producing liquid; and
a heating element operatively coupled to the boiler vessel and partially residing within the interior chamber thereof;
the heating element, when activated, being operative to facilitate the conversion of any vapor producing liquid within the interior chamber from a liquid to a vapor.

17. The leak detection device of claim 16 further comprising:
a storage reservoir for storing a prescribed volume of the vapor producing liquid;
a fluid flow line fluidly connecting the storage reservoir to the interior chamber of the boiler vessel; and
an injection pump which is integrated into the fluid flow line and, when activated, operative to pump the vapor producing liquid from the storage reservoir to the interior chamber of the boiler vessel.

18. The leak detection device of claim 17 wherein the heating element of the boiler assembly and the injection pump are each electrically connected to a controller of the leak detection device which is operative to facilitate the independent control and operation of the heating element and the injection pump.

19. The leak detection device of claim 18 wherein the controller, the heating element of the boiler assembly, the injection pump and the blower are each electrically connected to a power supply of the leak detection device which is disposed within the housing thereof.

20. A leak detection device, comprising:
a blower;
an air conduit fluidly connected to the blower; and
a boiler assembly operative to convert a vapor producing liquid infused therein from a liquid to a vapor, the boiler assembly including a vapor discharge nozzle which facilitates the fluid coupling thereof to the air conduit;
the discharge nozzle and the air conduit being sized and configured relative to each other such that the discharge nozzle is thermally decoupled from the air conduit, and the discharge nozzle protrudes into the air conduit to a maximum depth in a range of from about one quarter inch to about one half inch.
